(19) United States
(12) Patent Application Publication
(10) Pub. No.: US 2013/0231862 A1
(43) Pub. Date: Sep. 5, 2013

(54) CUSTOMIZABLE ROUTE PLANNING

(71) Applicant: MICROSOFT CORPORATION, Redmond, WA (US)

(72) Inventors: Daniel Delling, Mountain View, CA (US); Renato F. Werneck, San Francisco, CA (US)

(73) Assignee: Microsoft Corporation, Redmond, WA (US)

(21) Appl. No.: 13/868,135

(22) Filed: Apr. 23, 2013

Related U.S. Application Data
(63) Continuation-in-part of application No. 13/152,313, filed on Jun. 3, 2011.

(51) Int. Cl. G01C 21/34

(52) U.S. Cl. CPC G01C 21/34
USPC 701/527

(57) ABSTRACT

Customizable route planning is a technique for computing point-to-point shortest paths in road networks. It includes three phases: preprocessing, customization, and queries. The preprocessing phase partitions a graph into multiple levels of loosely connected components of bounded size and creates an overlay graph for each level by replacing each component with a clique connecting its boundary vertices. Clique edge lengths are computed during the customization phase. The query phase comprises a bidirectional Dijkstra's algorithm operating on the union of the overlay graphs and the components of the original graph containing the origin and the destination. The customization may be made even faster, enabling a wide range of applications including highly dynamic applications and on-line personalized cost functions. In an implementation, to compute overlay arc costs, Dijkstra's algorithm may be supplemented or replaced by other techniques, such as contraction and the Bellman-Ford algorithm.

### CROSS-REFERENCE TO RELATED APPLICATIONS

This application is a continuation-in-part of pending U.S. patent application Ser. No. 13/152,313, “CUSTOMIZABLE ROUTE PLANNING,” filed Jun. 3, 2011, the entire content of which is hereby incorporated by reference.

### BACKGROUND

Existing computer programs known as road-mapping programs provide digital maps, often complete with detailed road networks down to the city-street level. Typically, a user can input a location and the road-mapping program will display an on-screen map of the selected location. Several existing road-mapping products typically include the ability to calculate a best route between two locations. In other words, the user can input two locations, and the road-mapping program will compute the travel directions from the source location to the destination location. The directions are typically based on distance, travel time, etc. Computing the best route between locations may require significant computational time and resources.

Some road-mapping programs compute shortest paths using variants of a well known method attributed to Dijkstra. Note that in this sense “shortest” means “least cost” because each road segment is assigned a cost or weight not necessarily directly related to the road segment's length. By varying the way the cost is calculated for each road, shortest paths can be generated for the quickest, shortest, or preferred routes. Dijkstra's original method, however, is not always efficient in practice, due to the large number of locations and possible paths that are scanned. Instead, many known road-mapping programs use heuristic variations of Dijkstra's method.

More recent developments in road-mapping algorithms utilize a two-stage process comprising a preprocessing phase and a query phase. During the preprocessing phase, the graph or map is subject to an off-line processing such that later real-time queries between any two destinations on the graph can be made more efficiently. Known examples of preprocessing algorithms use geometric information, hierarchical decomposition, and A* search combined with landmark distances.

Most previous research focused on a metric directed to driving times. Real-world systems, however, often support other metrics such as shortest distance, walking, biking, avoiding U-turns, avoiding freeways, preferring freeways, or avoiding left turns, for example. Current road-mapping techniques are not adequate in such scenarios. The preprocessing phase is rerun for each new metric, and query times may not be competitive for metrics with weak hierarchies.

### SUMMARY

A point-to-point shortest path technique is described that supports real-time queries and fast metric update or replacement (also referred to as metric customization). Arbitrary metrics (cost functions) are supported without significant degradation in performance. Examples of metrics include current (real-time) traffic speeds, a truck with height, weight, and speed restrictions, user-specific customization, etc.

In an implementation, determining a shortest path between two locations uses three stages: a preprocessing stage, a metric customization stage, and a query stage. Preprocessing is based on a graph structure only, while metric customization augments preprocessing results taking edge costs into account. A graph may comprise a set of vertices (representing intersections) and a set of edges or arcs (representing road segments). Additional data structures may be used to represent turn restrictions and penalties.

In an implementation, the preprocessing partitions the graph into loosely connected components (or cells) of bounded size and creates an overlay graph by replacing each component with a “clique” (complete graph) connecting its boundary vertices. The preprocessing phase does not take edge costs into account, and is therefore metric-independent. Clique edge lengths are computed during the customization phase and stored separately. The customization phase can be repeated for various different metrics, and produces a small amount of data for each.

In an implementation, the query phase is run using the metric-independent data together with the relevant metric-specific data. The query phase may use a bidirectional version of Dijkstra's algorithm operating on the union of the overlay graph and the components of the original graph containing the origin and the destination. This graph is much smaller than the input graph, leading to fast queries. Multiple overlay levels may be used to achieve further speedup.

In some implementations, the customization stage may be made faster, by supplementing or replacing Dijkstra's algorithm with other techniques, such as contraction and the Bellman-Ford algorithm.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is a diagram illustrating three stages of an implementation of customizable route planning;

FIG. 3 is an operational flow of an implementation of a method using a metric customization technique for determining a shortest path between two locations;

FIG. 4 is an operational flow of an implementation of a contraction method for use with a metric customization technique;

FIG. 5 is an operational flow of an implementation of a contraction order method for use with customizable route planning;

FIG. 6 is an operational flow of an implementation of a microinstruction method for use with customizable route planning; and

FIG. 7 shows an exemplary computing environment.

### DETAILED DESCRIPTION

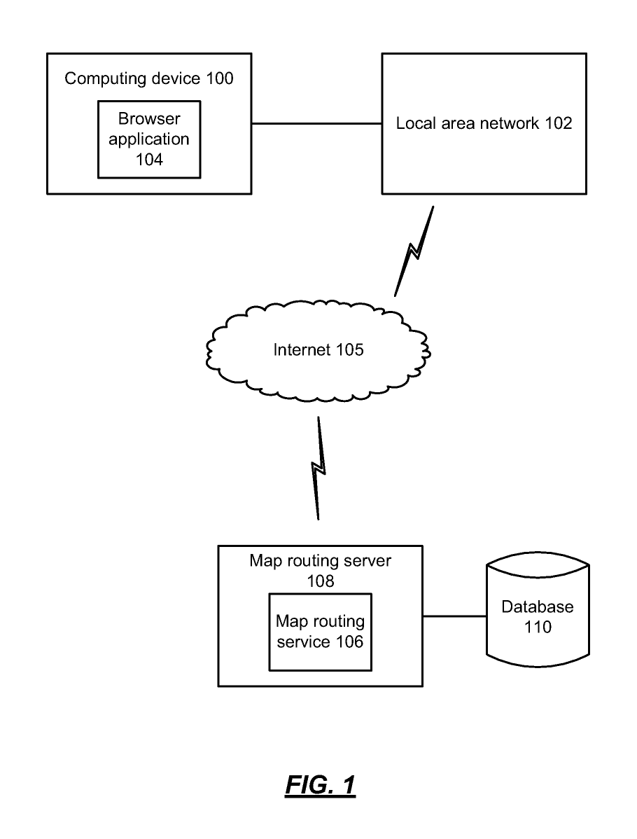

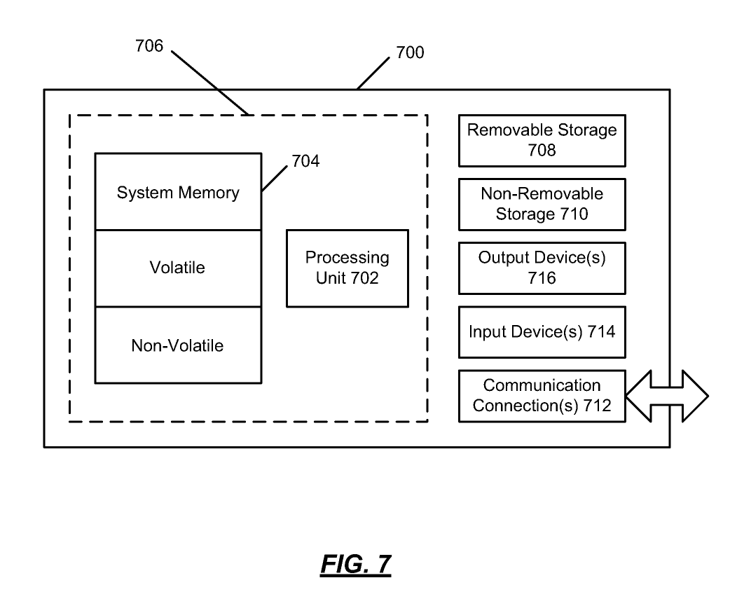

FIG. 1 shows an example of a computing environment in which aspects and embodiments may be potentially exploited. A computing device 100 includes a network interface card (not specifically shown) facilitating communications over a communications medium. Example computing devices include personal computers (PCs), mobile communication devices, etc. In some implementations, the computing device 100 may include a desktop personal computer, workstation, laptop, PDA (personal digital assistant), smart phone, cell phone, or any WAP-enabled device or any other computing device capable of interfacing directly or indirectly with a network. An example computing device 100 is described with respect to the computing device 700 of FIG. 7, for example.

The computing device 100 may communicate with a local area network 102 via a physical connection. Alternatively, the computing device 100 may communicate with the local area network 102 via a wireless wide area network or wireless local area network media, or via other communications media. Although shown as a local area network 102, the network may be a variety of network types including the public switched telephone network (PSTN), a cellular telephone network (e.g., 3G, 4G, CDMA, etc), and a packet switched network (e.g., the Internet). Any type of network and/or network interface may be used for the network.

The user of the computing device 100, as a result of the supported network medium, is able to access network resources, typically through the use of a browser application 104 running on the computing device 100. The browser application 104 facilitates communication with a remote network over, for example, the Internet 105. One exemplary network resource is a map routing service 106, running on a map routing server 108. The map routing server 108 hosts a database 110 of physical locations and street addresses, along with routing information such as adjacencies, distances, speed limits, and other relationships between the stored locations. The database 110 may also store information pertaining to metrics.

A user of the computing device 100 typically enters start and destination locations as a query request through the browser application 104. The map routing server 108 receives the request and produces a shortest path among the locations stored in the database 110 for reaching the destination location from the start location. The map routing server 108 then sends that shortest path back to the requesting computing device 100. Alternatively, the map routing service 106 is hosted on the computing device 100, and the computing device 100 need not communicate with a local area network 102.

The point-to-point (P2P) shortest path problem is a classical problem with many applications. Given a graph G with non-negative arc lengths as well as a vertex pair (s,t), the goal is to find the distance from s to t. The graph may represent a road map, for example. For example, route planning in road networks solves the P2P shortest path problem. However, there are many uses for an algorithm that solves the P2P shortest path problem, and the techniques, processes, and systems described herein are not meant to be limited to maps.

Thus, a P2P algorithm that solves the P2P shortest path problem is directed to finding the shortest distance between any two points in a graph. Such a P2P algorithm may comprise several stages including a preprocessing stage and a query stage. The preprocessing phase may take as an input a directed graph. Such a graph may be represented by G=(V,E), where V represents the set of vertices in the graph and E represents the set of edges or arcs in the graph. The graph comprises several vertices (points), as well as several edges. On a road network, the vertices may represent intersections, and the edges may represent road segments. The preprocessing phase may be used to improve the efficiency of a later query stage, for example.

During the query phase, a user may wish to find the shortest path between two particular nodes. The origination node may be known as the source vertex, labeled s, and the destination node may be known as the target vertex labeled t. For example, an application for the P2P algorithm may be to find the shortest distance between two locations on a road map. Each destination or intersection on the map may be represented by one of the nodes, while the particular roads and highways may be represented by an edge. The user may then specify their starting point s and their destination t. Alternatively, s and t may be points along arcs as well. The techniques described herein may also be used if the start and destination are not intersections, but points alongside a road segment (e.g., a particular house on a street).

Thus, to visualize and implement routing methods, it is helpful to represent locations and connecting segments as an abstract graph with vertices and directed edges. Vertices correspond to locations, and edges correspond to road segments between locations. The edges may be weighted according to the travel distance, transit time, and/or other criteria about the corresponding road segment. The general terms “length” and “distance” are used in context to encompass the metric by which an edge's weight or cost is measured. The length or distance of a path is the sum of the weights of the edges contained in the path. For manipulation by computing devices, graphs may be stored in a contiguous block of computer memory as a collection of records, each record representing a single graph node or edge along with some associated data. Not all the data must be stored with the graph; for example, the actual edge weights may be stored separately.

Arcs and turns have properties such as physical length, speed limit, height or weight restriction, tolls, road category (e.g., highway, rural road, etc.), turn type (e.g., “left turn with stop sign”, etc.). A metric is a function that maps properties to costs, such as fastest, shortest, avoid highways, avoid tolls, no U-turns, etc. Metrics may share the same underlying graph.

For customizable route planning, real-time queries may be performed on road networks with arbitrary metrics. Such techniques can be used to keep several active metrics at once (e.g., to answer queries for any of them), or so that new metrics can be generated on the fly, for example. Customizable route planning supports real-time traffic updates and other dynamic query scenarios, allows arbitrary metric customization, and can provide personalized driving directions (for example, for a truck with height and weight restrictions).

The information associated with the network can be split into two elements: the topology and a metric. The topology includes the set of vertices (intersections) and edges (road segments), and how they relate to one another. It also includes a set of static properties of each road segment or turn, such as physical length, road category, speed limits, and turn types. A metric encodes the actual cost of traversing a road segment (i.e., an edge) or taking a turn. A metric may be described compactly, as a function that maps (in constant time) the static properties of an edge or turn into a cost. As used herein, the topology is shared by the metrics and rarely changes, while metrics may change often and may coexist.

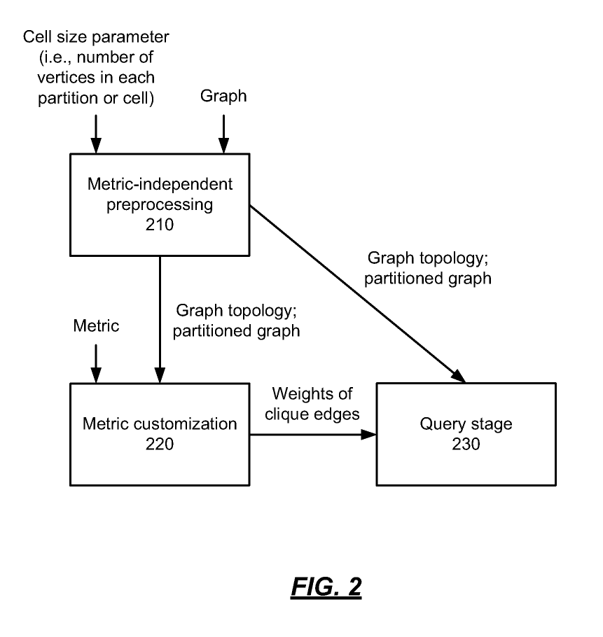

Techniques for customizable route planning comprise three stages, as shown in the high level diagram of FIG. 2. A first stage, at 210, is referred to as metric-independent preprocessing. This preprocessing takes the graph topology as input, and may produce a fair amount of auxiliary data (comparable to the input size). The second stage, at 220, is metric customization, and is run once for each metric, is fast (e.g., on the order of a few seconds), and produces little data—an amount that is a small fraction of the original graph. One of the inputs to the metric customization stage is a description of the metric. In this manner, the metric customization knows (implicitly or explicitly) the cost of every road segment or turn. The third stage, at 230, is the query stage. The query stage uses the outputs of the first two stages and is fast enough for real-time applications.

A metric customization technique may be used in the determination of point-to-point shortest paths. In implementations, the metric customization time, the metric-dependent space (excluding the original graph), and the query time, are minimized. Although examples herein may refer to travel times and travel distances, the techniques may be used for any metric.

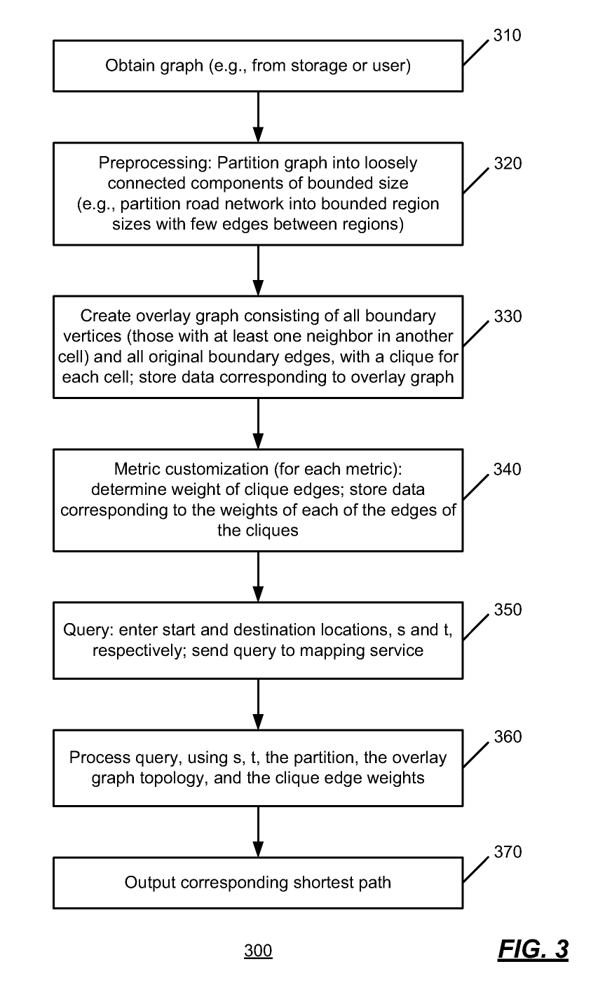

FIG. 3 is an operational flow of an implementation of a method 300 using a metric customization technique for determining a shortest path between two locations. At 310, a graph is obtained, e.g., from storage or from a user.

During a preprocessing stage, the graph is partitioned into loosely connected components of bounded size at 320. In an implementation, this operation partitions the road network into bounded region sizes with few edges between regions. At 330, an overlay graph is created by replacing each component with a complete graph (a “clique”) connecting its boundary vertices. Preprocessing performs the partition and builds the overlay graph (i.e., the cliques), but without taking edge weights into account. Thus, at 330, an overlay graph is created, comprising the boundary vertices (those with at least one neighbor in another cell) and the original boundary edges, together with a clique for each cell.

More particularly, given the graph G(V,E) as an input along with an input parameter U, a partition into cells with at most U vertices each is generated with as few boundary arcs (arcs with endpoints in different cells) as possible, and an overlay graph is created. This preprocessing stage is metric-independent and ignores edge costs.

Any known method, such as the well known PUNCH technique, may be used to partition the graph. Recently developed to deal with road networks, PUNCH routinely finds solutions with half as many boundary edges (or fewer), compared to the general-purpose partitioners (such as METIS) commonly used by previous algorithms. Better partitions reduce customization time and space, leading to faster queries.

The overlay graph H created during preprocessing contains all boundary vertices in the partition, i.e., all vertices with at least one neighbor in another cell. It also includes all boundary edges (i.e., every edge whose endpoints are in different cells). Finally, for each cell C, it contains a complete graph (a clique) between its boundary vertices. For every pair (v,w) of boundary vertices in C, H contains an arc (v,w).

The preprocessing is based on the graph structure without any edge costs, while subsequent metric customization augments the preprocessing results by taking edge costs into account. For the customization stage, the distances between the boundary nodes in each cell are determined. Therefore, during a metric customization stage, given the input of graph G=(V,E), a partition of V, and the overlay graph topology, the weights of clique edges are determined. Clique edge weights (i.e., lengths) are thus computed during the customization phase (i.e., the metric customization stage assigns weights to the edges of the cliques). This stage can be repeated for various different metrics, and produces a small amount of data for each.

More particularly, during the metric customization stage, at 340, for every pair (v, w) of boundary vertices in C, the cost of the clique arc (v, w) is set to the length of the shortest path (restricted to C) between v and w (or infinite if w is not reachable from v). This may be performed by running a Dijkstra computation from each boundary vertex u restricted to the cell containing u. Note that, with these costs, H is an overlay: the distance between any two vertices in H is the same as in G. Thus, by separating metric customization from graph partitioning, new metrics may be processed quickly.

At query time, at 350, a user enters start and destination locations, s and t, respectively (e.g., using the computing device 100), and the query (e.g., the information pertaining to the s and t vertices) is sent to a mapping service (e.g., the map routing service 106). The s-t query is processed at 360 using the partition, the overlay graph topology, and the clique edge weights. Depending on the implementation, one can have arbitrarily many queries after a single customization operation. The query is processed using the metric-independent data together with the relevant metric-specific data. A bidirectional version of Dijkstra's algorithm is performed on the union of the overlay graph H and the components of the original graph G containing the origin and the destination. (A unidirectional algorithm can also be used.) Thus, to perform a query between s and t, run a bidirectional version of Dijkstra's algorithm on the graph consisting of the union of H, Cₛ, and Cₜ. (Here Cᵥ denotes the subgraph of G induced by the vertices in the cell containing v.) This graph is much smaller than the input graph, leading to fast queries. The corresponding path (the distance between s and t) is outputted to the user at 370 as the shortest path.

The customizable route planning technique may be improved using a variety of techniques, such as multiple overlay levels, turn tables (e.g., using matrices), stalling, and path unpacking.

Multiple overlay levels may be used to achieve further speedup. In other words, to accelerate queries, multiple levels of overlay graphs may be used. Instead of using a single parameter U as input, one may use a sequence of parameters U₁, . . . , Uₖ of increasing value. Each level is an overlay of the level below. Nested partitions of G are obtained, in which every boundary edge at level i is also a boundary edge at level i−1, for i>1. The level-0 partition is the original graph, with each vertex as a cell. For the i-th level partition, create a graph Hᵢ that includes all boundary arcs, plus an overlay linking the boundary vertices within a cell. The well known PUNCH technique, for example, may be used to create multilevel partitions, in top-down fashion. With multiple levels, an s-t query runs bidirectional Dijkstra on a restricted graph Gₛₜ. An arc (v,w) from Hᵢ will be in Gₛₜ if both v and w are in the same cell as s or t at level i+1. The weights of the clique edges in Hᵢ can be computed during the metric customization phase using only Hᵢ₋₁.

Customization times are typically dominated by building the overlay of the lowest level, since it works on the underlying graph directly (higher levels work on the much smaller cliques of the level below). In this case, smaller cells tend to lead to faster preprocessing. Therefore, as an optimization, an implementation may use one or more phantom levels with very small cells (e.g., with U=32 and/or U=256) to accelerate customization. The phantom levels are only used during customization and are not used during the query stage. Thus, the phantom levels are disregarded for queries, thereby keeping space usage unaffected. In this manner, less space is used and metric customization times are small.

In an implementation, the weights of the clique edges corresponding to each cell of the partition may be represented as a matrix containing the distances among the cell's entry and exit vertices (these are the vertices with at least one incoming or outgoing boundary arc, respectively; most boundary vertices are both). These distances can be represented as 32-bit integers, for example. To relate each entry in the matrix to the corresponding clique edge, one may use arrays to associate rows (and columns) with the corresponding vertex IDs. These arrays are small and can be shared by the metrics, since their meaning is metric-independent. Compared to a standard graph representation, matrices use less space and can be accessed more cache-efficiently.

Thus far, only a standard representation of road networks has been considered, with each intersection corresponding to a single vertex. This does not account for turn costs or restrictions. Any technique can handle turns by working on an expanded graph. A conventional representation is arc-based: each vertex represents one exit point of an intersection, and each arc is a road segment followed by a turn. This representation is wasteful in terms of space usage, however.

Instead, a compact representation may be used in which each intersection on the map is represented as a single vertex with some associated information. If a vertex u has p incoming arcs and q outgoing arcs, associate a p×q turn table Tᵤ to it, where Tᵤ[i,j] represents the turn from the i-th incoming arc into the j-th outgoing arc. In an example customizable setting, each entry represents a turn type (such as “left turn with stop sign”), since the turn type's cost may vary with different metrics. In addition, store with each arc (v,w) its tail order (its position among v's outgoing arcs) and its head order (its position among w's incoming arcs). These orders may be arbitrary. Since vertex degrees are small on road networks, four bits for each may suffice.

Turn tables are determined for each intersection on the map. It is often the case that many intersections share the exact same table. Each unique table is an intersection type. To save space, each type of intersection (turn table) may be stored in a memory or storage device only once and is assigned a unique identifier. Instead of storing the full table, each node stores just the identifier of its intersection type. This is a small space overhead. On typical continental road networks, the total number of such intersection types is modest—in the thousands rather than millions. For example, many vertices in the United States represent intersections with four-way stop signs.

Dijkstra's algorithm, however, becomes more complicated with the compact representation of turns. In particular, it may now visit each vertex (intersection) multiple times, once for each entry point. It essentially simulates an execution on the arc-based expanded representation, which increases its running time by a factor of roughly four. The slowdown can be reduced to a factor of about two with a stalling technique. When scanning one entry point of an intersection, one may set bounds for its other entry points, which are not scanned unless their own distance labels are smaller than the bounds. These bounds depend only on the turn table associated with the intersection, and can be computed during customization.

To support the compact representation of turns, turn-aware Dijkstra is used on the lowest level (but not on higher ones), both for metric customization and queries. Matrices in each cell represent paths between incoming and outgoing boundary arcs (and not boundary vertices, as in the representation without turns). The difference is subtle. With turns, the distance from a boundary vertex v to an exit point depends on whether the cell is entered from an arc (u,v) or an arc (w,v), so each arc has its own entry in the matrix. Since most boundary vertices have only one incoming (and outgoing) boundary arc, the matrices are only slightly larger.

As described so far, queries may find a path from the source s to the destination t in the overlay graph. In an implementation, following the parent pointers of the meeting vertex of forward and backward searches, a path is obtained with the same length as the shortest s-t path in the original graph G, but it may contain shortcuts. If the full list of edges in the corresponding path in G is to be obtained, one may perform a path unpacking routine.

Path unpacking consists of repeatedly converting each level-i shortcut into the corresponding arcs (or shortcuts) at level i−1. To unpack a level-i shortcut (v,w) within cell C, run bidirectional Dijkstra on level i-1 restricted to C to find the shortest v-w path using only shortcuts at level i−1. The procedure is repeated until no shortcuts remain in the path (i.e., until all edges are at level 0).

Running bidirectional Dijkstra within individual cells is usually fast enough for path unpacking. Using four processing cores as an example, unpacking less than doubles query times, with no additional customization space. For even faster unpacking, one can compute additional information to limit the search spaces further. One can store a bit with each arc at level i indicating whether it appears in a shortcut at level i+1. In other words, during customization, mark the arcs with a single bit to show that it is part of a shortcut. Thus, during queries involving unpacking, one only has to look at arcs that have the bit set.

As described so far, customizable route planning is a fast technique for computing point-to-point shortest paths in road networks. It includes three phases: preprocessing, customization, and queries. The preprocessing phase partitions a graph into multiple levels of loosely connected components (or cells) of bounded size and creates an overlay graph for each level by replacing each component with a clique connecting its boundary vertices. Clique edge lengths are computed during the customization phase. The query phase comprises a bidirectional Dijkstra's algorithm operating on the union of the overlay graphs and the components of the original graph containing the origin and the destination. This search graph is much smaller than the input graph, leading to fast queries.

The customization may be made even faster (e.g., by speeding up its operation of computing the lengths of the shortcuts within each cell), enabling a wide range of applications including highly dynamic applications and on-line personalized cost functions. In an implementation, to compute overlay arc costs, Dijkstra's algorithm may be supplemented or replaced by other techniques, such as contraction and the Bellman-Ford algorithm. Although these other approaches may increase the number of operations (such as arc scans) performed, better locality may be obtained, and parallelism may be enabled at instruction and core levels. The various techniques described herein may be used alone or in conjunction with each other.

In an implementation, contraction may be used to accelerate the customization phase, by iteratively removing vertices from the graph while adding additional edges to preserve the distances among the others. To process a cell, contract its internal vertices while preserving its boundary vertices. Thus, instead of computing shortest paths explicitly, eliminate internal vertices from a cell one by one, adding new arcs as needed to preserve distances; the arcs that eventually remain are the desired shortcuts (between the entry and exit points of the cell). For efficiency, not only is the order precomputed in which vertices are contracted, but also the graph itself is abstracted away. In an implementation, during customization, the actual contraction may be simulated by following a (precomputed) series of instructions describing the basic operations (memory reads and writes) the contraction routine would perform.

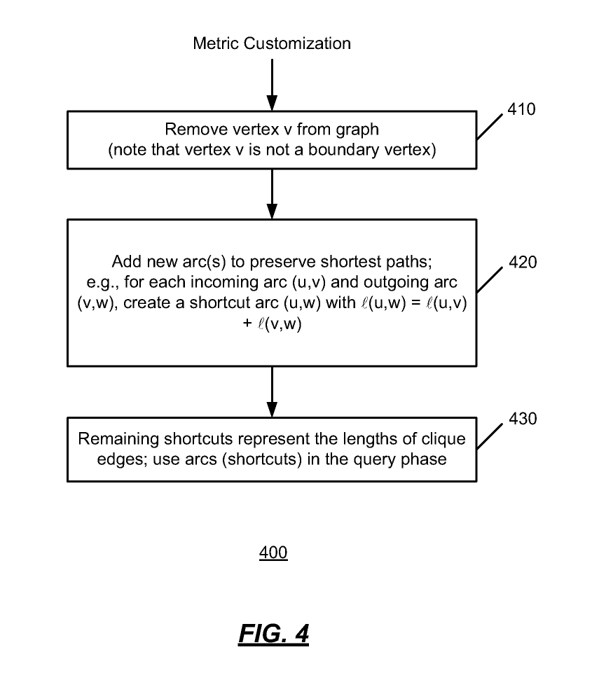

FIG. 4 is an operational flow of an implementation of a contraction method 400 for use with a metric customization technique. The contraction approach is based on the shortcut operation and is used during customization. During a customization phase (e.g., the stage at 220 described above with respect to FIG. 2, or the stage at 340 described above with respect to FIG. 3), to shortcut a vertex v, at 410, the vertex v is removed from the graph, and new arcs are added to preserve shortest paths at 420. It is noted that vertex v is not a boundary vertex (as boundary vertices are not contracted during customization). At 420 for example, for each incoming arc (u,v) and outgoing arc (v,w), create a shortcut arc (u,w) with l(u,w)=l(u,v)+l(v,w). The shortcut may be temporarily added to the partitioned graph to represent a path between u and w. In many applications, a shortcut is only added if it represents the only shortest path between its endpoints in the remaining graph (without v), which can be tested by running a witness search (i.e., a local Dijkstra search) between its endpoints. The remaining shortcuts represent the lengths of clique edges. The arcs (shortcuts) in the final graph at 430 may then be used in the query phase.

The performance of contraction strongly depends on the cost function. With travel times in free-flow traffic (a common case), it works very well. Even for continental instances, sparsity is preserved during the contraction process, and the number of arcs less than doubles. Other metrics often need more shortcuts, which leads to denser graphs and makes finding the contraction order much more expensive.

Within the customizable route planning framework, these issues can be addressed by exploiting the separation between metric-independent preprocessing and customization. During preprocessing, a contraction order to be used by all metrics may be determined. In an implementation, the contraction order may minimize the number of operations performed during contraction. To ensure this order works well even in the worst case, assume that every potential shortcut will be added. Accordingly, do not use witness searches during customization. For maximum efficiency, precompute a sequence of microinstructions to describe the entire contraction process in terms of basic operations, as described further herein.

Computing a contraction order that minimizes the number of shortcuts added (or operations performed) is NP-hard. In practice, one may use on-line heuristics that pick the next vertex to contract based on a priority function that depends on local properties of the graph. A typical criterion is the difference between the number of arcs added and removed if a vertex v were contracted.

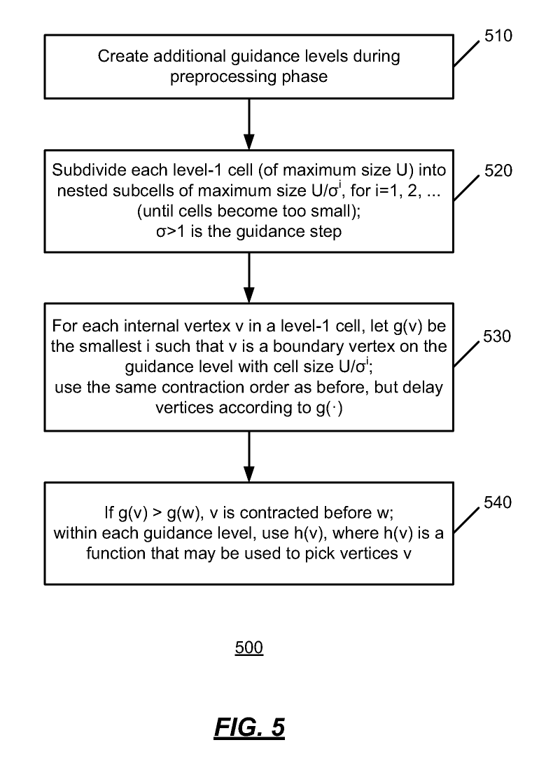

In an implementation, partitions may be used to guide the contraction order. FIG. 5 is an operational flow of an implementation of a contraction order method 500 for use with customizable route planning. At 510, additional guidance levels are created during the preprocessing phase (e.g., the stage at 210 described above with respect to FIG. 2, or the stage at 320 described above with respect to FIG. 3), extending the standard customizable route planning multilevel partition downward (to even smaller cells).

At 520, subdivide each level-1 cell (of maximum size U) into nested subcells of maximum size U/σⁱ, for i=1, 2, . . . (until cells become too small). Here σ>1 is the guidance step.

At 530, for each internal vertex v in a level-1 cell, let g(v) be the smallest i such that v is a boundary vertex on the guidance level with cell size U/σⁱ. Use the same contraction order as before, but delay vertices according to g(•).

At 540, if g(v)>g(w), v is contracted before w; within each guidance level, use h(v), where h(v) is a function that may be used to pick vertices v. For example, in an implementation, vertices v may be selected that minimize h(v), where h(v)=100sc(v)−ia(v)−oa(v), which uses parameters such as the number ia(v) of incoming arcs, the number oa(v) of outgoing arcs, and the number sc(v) of shortcuts created (or updated) if v is contracted. Other functions h(v) may be used depending on the implementation.

While the contraction order is determined during the metric-independent phase of customizable route planning, the contraction can only be executed (by following the order) during customization, once the arc lengths are known. Even with the order given, this execution may be expensive (time consuming, resource-intensive, etc.). To contract v, the costs (and endpoints) of its incident arcs are retrieved, and then each potential shortcut (u,w) is processed by either inserting it or updating its current value. This uses data structures supporting arc insertions and deletions, and, even checking if a shortcut already exists, gets costlier as degrees increase. Each fundamental operation, however, is straightforward: read the costs of two arcs, add them up, compare the result with the cost of a third arc, and update it if needed. The contraction routine can therefore be fully specified by a sequence of triples (a,b,c) (e.g., an instruction array). Each element in the triple is a memory position holding an arc (or shortcut) length. So read the values in a and b and write the sum to c if there is an improvement.

As described above, contraction may be implemented using a dynamic graph data structure. However, this may be too slow for certain applications. Instead, in an implementation, microcode for contraction may be used in which the preprocessing phase may be used to store the memory positions that are read from and written to explicitly in a list. The customization phase then executes this instruction list. This list can be optimized to improve locality.

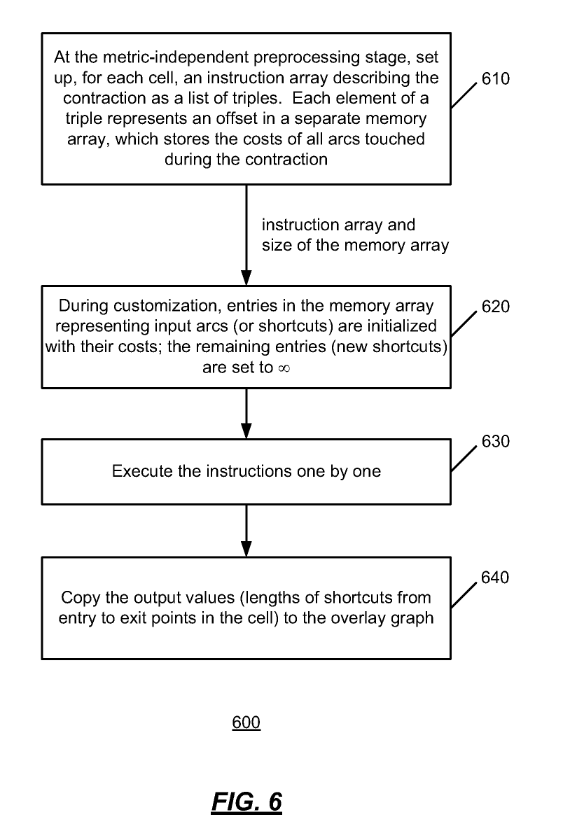

FIG. 6 is an operational flow of an implementation of a microinstruction method 600 for use with customizable route planning. At 610, because the sequence of operations is the same for any cost function, use the metric-independent preprocessing stage to set up, for each cell, an instruction array describing the contraction as a list of triples. Each element of a triple represents an offset in a separate memory array, which stores the costs of all arcs (temporary or otherwise) touched during the contraction. The preprocessing stage outputs the entire instruction array as well as the size of the memory array.

At 620, during customization, entries in the memory array representing input arcs (or shortcuts) are initialized with their costs; the remaining entries (new shortcuts) are set to ∞. At 630, the instructions are executed one by one, and at 640, output values (lengths of shortcuts from entry to exit points in the cell) are copied to the overlay graph. With this approach, the graph itself is abstracted away during customization. There is no need to keep track of arc endpoints, and there is no notion of vertices at all. The code just manipulates numbers (which happen to represent arc lengths). This is cheaper and less complex than operating on an actual graph.

Although the space used by the instruction array is metric-independent (shared by all cost functions), it can be quite large. It may be kept manageable by representing each triple with as few bits as necessary to address the memory array. In addition, use a single macroinstruction to represent the contraction of a vertex v whenever the resulting number of writes exceeds an unrolling threshold τ. This instruction explicitly lists the addresses of v's cᵢₙ incoming and cₒᵤₜ outgoing arcs, followed by the corresponding cᵢₙ·cₒᵤₜ write positions. The customization phase loops over the incoming and outgoing positions, which is slower than reading tuples but saves space. It is contemplated that other instruction representations can be used to reduce the contraction cost.

Contraction works well on the first overlay level, because it operates directly on the underlying graph, which is sparse. Density quickly increases during contraction, however, making it expensive as cell sizes increase. On higher levels, shortest paths may be computed explicitly (as before), but each computation can be made more efficient by replacing the Dijkstra algorithm with lightweight algorithms that work better on small graphs, and applying techniques to reduce the size of the search graph.

In other words, although contraction could be used to process the entire hierarchy, it is not as effective at higher levels as it is at level-1 cells, because the graphs within each higher-level cell are much denser. In such cases, it is cheaper to run graph searches. In some implementations, search-based techniques may be used to accelerate higher levels of the hierarchy.

In an implementation, the search graph may be pruned. To process a cell C, compute the distances between its entry and exit points. For example, the graph GC being operated on within the cell C is the union of subcell overlays (complete bipartite graphs) with some boundary arcs between them. Instead of searching GC directly, first contract its internal exit points. Because each such vertex has out-degree one (its outgoing arc is a boundary arc within C), this reduces the number of vertices and edges in the search graph. Note that C's own exit points are preserved (they are the targets of our searches), but they do not need to be scanned (they have no outgoing arcs).

In an implementation, locality may be improved. Conceptually, to process a cell C, the full overlay graph may be operated on, but restricting the searches to vertices inside C. For efficiency, copy the relevant subgraph to a separate memory location, run the searches on it, then copy the results back. This simplifies the searches (there are no special cases), allows the use of sequential local IDs, and improves locality.

Contraction is a good approach for the lowest levels of the hierarchy. However, on the topmost levels, graph algorithms may be preferable. For example, the well- known Bellman-Ford algorithm may be used (instead of the Dijkstra algorithm) to compute the edge lengths of the clique edges. The Bellman-Ford algorithm can be further accelerated using instruction-level parallelism (e.g., SSE (streaming SIMD extensions) or AVX (Advanced Vector Extensions) instructions). Locality can be improved by operating on partially contracted subgraphs representing small cells.

Thus, customization may be further accelerated by replacing Dijkstra's algorithm in the metric customization stage (e.g., 220 of FIG. 2, or 340 of FIG. 3) with the well-known Bellman-Ford algorithm. The Bellman-Ford algorithm starts by setting the distance label of the source to 0, and all others to ∞. Each round then scans each vertex once, updating the distance label of its neighbors appropriately. For better performance, only scan vertices that are active (i.e., whose distance improved since the previous scan), and stop when there is no active vertex left.

While the Bellman-Ford algorithm cannot scan fewer vertices than Dijkstra, its simplicity and better locality make it competitive. The number of rounds is bounded by the maximum number of arcs on any shortest path, which is small for reasonable metrics but linear in the worst case. Therefore, in an implementation, switch to Dijkstra's algorithm whenever the number of Bellman-Ford rounds reaches a given (constant) threshold.

It is contemplated that other techniques may be used besides Bellman-Ford, such as the well-known Floyd-Warshall algorithm. The Floyd-Warshall algorithm computes shortest paths among all vertices in the graph, and for use herein, only extract the relevant distances. Its running time is cubic, but with its tight inner loop and good locality, it could be competitive with the Bellman-Ford algorithm on denser graphs.

In an implementation, multiple-source executions may be used. Multiple runs of Dijkstra's algorithm (from different sources) can be accelerated if combined into a single execution. This approach may be applied to the Bellman-Ford algorithm. Let k be the number of simultaneous executions, from sources s₁, . . . , sₖ. For each vertex v, keep k distance labels: d₁(v), . . . , dₖ(v). The dᵢ(sᵢ) values are initialized to zero (each sᵢ is the source of its own search), and the remaining dᵢ(·) values are set to ∞. The k sources sᵢ are initially marked as active. When the Bellman-Ford algorithm scans an arc (v,w), try to update all k distance labels of w at once: for each i, set dᵢ(w) →min{dᵢ(w), dᵢ(v)+l(v,w)}. If any such distance label actually improves, mark w as active. This simultaneous execution uses as many rounds as the worst of the k sources, but, by storing the k distances associated with a vertex contiguously in memory, locality is much better. In addition, it enables instruction-level parallelism, described further below.

Modern CPUs have extended instruction sets with SIMD (single instruction, multiple data) operations, which work on several pieces of data at once. In particular, the SSE instructions available in x86 CPUs can manipulate special 128-bit registers, allowing basic operations (such as additions and comparisons) on four 32-bit words in parallel.

Consider the simultaneous execution of the Bellman-Ford algorithm from k=4 sources, as above. When scanning v, first store v's four distance labels in one SSE register. To process an arc (v,w), store four copies of l(v,w) into another register and use a single SSE instruction to add both registers. With an SSE comparison, check if these tentative distances are smaller than the current distance labels for w (themselves loaded into an SSE register). If so, take the minimum of both registers (in a single instruction) and mark w as active.

In addition to using SIMD instructions, core-level parallelism may be used by assigning cells to distinct cores. This may also be done for level-1 cells with microinstructions. In addition, parallelize the top overlay level (where there are few cells per core) by further splitting the sources in each cell into sets of similar size, and allocating them to separate cores (each accessing the entire cell).

In an implementation, more levels may be used during the customization stage and then some of those levels may be discarded. These additional levels, referred to as mezzanine levels, may be used to accelerate customization. These are intermediate partition levels that are used during customization (for speed), but not during queries (to save space). They are similar to the phantom levels described above, which are small (temporary) levels used to accelerate the customization of the lowest actual level in a hierarchy.

FIG. 7 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non- removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by computing device 700 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of determining a shortest path between two locations, comprising:
receiving as input, at a computing device, a graph comprising a plurality of vertices and edges;
partitioning the graph into a plurality of components of bounded size;
generating an overlay graph by replacing each of the plurality of components with a clique connecting boundary vertices of the component;
for each of the plurality of cliques, determining the weight of each of the edges of the clique by performing contraction within the corresponding cell of the partitioned graph;
performing, by the computing device, a point-to-point shortest path computation for a query using the partitioned graph, the overlay graph, and the weights of each of the edges of the cliques; and
outputting the shortest path, by the computing device.

2. The method of claim 1, wherein performing the contraction comprises temporarily removing some of the vertices of the partitioned graph and adding additional edges to the partitioned graph.

3. The method of claim 1, wherein performing the contraction comprises removing a vertex v from the graph, and adding new arcs to preserve shortest paths of the graph.

4. The method of claim 3, wherein performing the contraction further comprises for each incoming arc (u,v) and outgoing arc (v,w), creating a shortcut arc (u,w) with l(u,w)=l(u,v)+l(v,w), and temporarily adding the shortcut to the partitioned graph to represent a path between u and w.

5. The method of claim 1, further comprising determining a contraction order prior to performing the contraction, and performing the contraction in the contraction order.

6. The method of claim 5, wherein the contraction order minimizes the number of operations performed during contraction.

7. The method of claim 5, wherein partitioning the graph, generating the overlay graph, and determining the contraction order are performed during a metric-independent preprocessing stage, wherein the contraction is performed during a metric customization stage, wherein the weights of each of the edges of the cliques are determined during the metric customization stage.

8. The method of claim 1, further comprising storing microcode for use in the contraction, wherein the microcode stores a list of memory positions that are read from and written to during contraction.

9. The method of claim 8, wherein the partitioned graph, the topology of the overlay graph, a contraction order, and the microcode are metric-independent.

10. The method of claim 1, wherein the graph represents a network of nodes.

11. The method of claim 1, wherein the graph represents a road map.

12. A method of determining a shortest path between two locations, comprising:
preprocessing, at a computing device, a graph comprising a plurality of vertices to generate preprocessed data comprising a partitioned graph, a contraction order, and microcode representing the instructions to be performed during contraction; and
performing metric customization on a metric using the partitioned graph,the contraction order, and the microcode, by the computing device.

13. The method of claim 12, wherein performing metric customization on the metric using the partitioned graph comprises performing a contraction the partitioned graph, in the contraction order, to determine the lengths of clique edges in an overlay graph.

14. The method of claim 13, wherein the contraction order minimizes the number of operations performed during the contraction.

15. The method of claim 13, further comprising, during the preprocessing, storing microcode for use in the contraction, wherein the microcode stores a list of memory positions that are read from and written to during contraction.

16. The method of claim 12, wherein the preprocessing is metric-independent, and further comprising:
creating an overlay graph by replacing each component with a clique connecting the boundary vertices of the component;
determining a length of an edge of the clique during the metric customization;
receiving a query at the computing device, the query comprising an origin location and a destination location;
performing, by the computing device, a point-to-point shortest path computation on the origin location and the destination location, wherein the point-to-point shortest path computation uses the partitioned graph, the overlay graph, and the length of the edge of the clique; and
outputting the shortest path, by the computing device.

17. A method of determining a shortest path between two locations, comprising:
receiving as input, at a computing device, a plurality of overlay graphs generated from a partitioned graph;
receiving as input, at the computing device, metric customization data for a metric representing the weights of clique edges of a clique for each cell, wherein the weights of the clique edges are based on contraction performed on the partitioned graph in a predetermined contraction order; and
performing, by the computing device, a point-to-point shortest path computation on a query using the partitioned graph and the weight of clique edges of the clique.

18. The method of claim 17, wherein the metric customization data is generated using at least one mezzanine level.

19. The method of claim 17, wherein the weights of the clique edges are determined using a Bellman-Ford algorithm.

20. The method of claim 17, wherein contraction is performed by executing predetermined microcode optimized to improve locality.
